(19) United States
(12) Patent Application Publication
(10) Pub. No.: US 2014/0240831 A1
(43) Pub. Date: Aug. 28, 2014

(54) Stabilization of High-Power WBC Systems

(71) Applicant: Bien Chann, Merrimack, NH (US)

(72) Inventor: Bien Chann, Merrimack, NH (US)

(73) Assignee: TERADIODE, INC., Wilmington, MA (US)

(21) Appl. No.: 14/093,407

(22) Filed: Nov. 29, 2013

Related U.S. Application Data
(60) Provisional application No. 61/730,544, filed on Nov. 28, 2012.

(51) Int. Cl. G02B 27/10; G02B 27/28

(52) U.S. Cl. CPC G02B 27/1006; G02B 27/283
USPC 359/489.08; 359/634

(57) ABSTRACT

A system and method for stabilizing WBC systems utilizing retro reflectors.

### BACKGROUND OF THE INVENTION

1. Field of the Invention

The present embodiments relate generally to laser systems and more particularly to wavelength beam combining systems and methods.

2. Description of the Prior Art

Wavelength beam combining (WBC) is a method for scaling the output power and brightness from laser diode bars, stacks of diode bars, as well as other lasers arranged in one or two-dimensional array.

WBC methods have been developed to combine beams along the slow or fast dimension of each emitter. The beam quality is limited to that of a single emitter; however, a plurality of emitters may be combined to produce a multi-wavelength output having the beam quality of a single emitter, but the power output of multiple emitters. WBC systems may be scaled to produce several kilowatts and even up to megawatts of output power. However, the increased output power places a greater burden to keep common components such as mirrors stable. Current methods include mounting such mirrors to mounts and plates that have an active cooling system.

The following application seeks to solve the problems stated and providing a stabilization system for increased power in WBC systems.

### SUMMARY OF THE INVENTION

A stabilized wavelength beam combiner comprising: a plurality of emitters each producing a beam; a collecting optic configured to receive and deliver the beams onto a dispersive element, wherein the dispersive element transmits the beams as a combined beam profile; a partially-reflecting output coupler arranged to receive the combined beams from the dispersive element, to reflect a portion of the combined beams toward the dispersive element, and to transmit the combined beams as a multi-wavelength beam comprising optical radiation having a plurality of wavelengths; and at least two retro reflectors disposed along the optical path of the beams between the emitters and the partially reflective output coupler.

### BRIEF DESCRIPTION OF THE DRAWINGS

FIG. 1A is a schematic of a wavelength beam combining (WBC) method along the array dimension of a single row of emitters.

FIG. 1B is a schematic of a WBC method along the array dimension of a two-dimensional array of emitters.

FIG. 1C is a schematic of a WBC method along the stack dimension of a two-dimensional array of emitters.

FIG. 2 is a schematic showing the effects of smile in a WBC method along the stack dimension of a two-dimensional array of diode laser emitters.

FIG. 3A is a schematic of a WBC system including an optical rotator selectively rotating a one-dimensional array of beams.

FIG. 3B is a schematic of a WBC system including an optical rotator selectively rotating a two-dimensional array of beams

FIG. 3C is a schematic of a WBC system including an optical rotator selectively reorienting a two-dimensional array of beams.

FIG. 3D illustrates output profile views of the system of FIG. 3C with and without an optical rotator.

FIGS. 4A-C illustrate examples of optical rotators.

FIGS. 5A-E illustrate various retro reflectors for use with a WBC system.

FIGS. 6A-B illustrates a basic schematic of a WBC system incorporating a plurality of mirrors and the angular and spatial feedback of an actual beam versus ideal beam.

FIGS. 7A-C illustrate replacing mirrors with retro reflectors and showing the ideal versus actual beam output and feedback both spatially and angularly

FIG. 8 illustrates an optical schematic of a WBC system configured to optically couple up to a kilowatt of power or more into an optical fiber having a small numerical aperture and small core diameter where the mirrors used could be replaced by retro reflectors to increase stability.

### DETAILED DESCRIPTION OF THE PREFERRED EMBODIMENT

Aspects and embodiments relate generally to the field of scaling laser sources to high-power and high-brightness using wavelength beam combining techniques. More particularly, methods for increasing brightness, stability, and effectiveness of wavelength beam combining systems.

Embodiments described herein include addressing increasing stabilization of WBC systems that create high amounts of power including those greater than 100 W, greater than 500 W, and greater than kilowatt. Through the various embodiments and techniques described herein a stabilized, high brightness multi-wavelength output laser system may be achieved.

The approaches and embodiments described herein may apply to one and two-dimensional beam combining systems along the slow-axis, fast-axis, or other beam combining dimension. For purposes of this application optical elements may refer to any of lenses, mirrors, prisms and the like which redirect, reflect, bend, collect or in any other manner optically manipulate electromagnetic radiation. Additionally, the term beam includes electromagnetic radiation. Beam emitters include any electromagnetic beam-generating device such as semiconductor elements, which generate an electromagnetic beam, but may or may not be self-resonating. These also include fiber lasers, disk lasers, non-solid state lasers, diode lasers and so forth. Generally each emitter is comprised of a back reflective surface, at least one optical gain medium, and a front reflective surface. The optical gain medium refers to increasing the gain of electromagnetic radiation and is not limited to the visual, IR or ultraviolet portions of the electromagnetic spectrum. An emitter, may be comprised of multiple beam emitters such as a diode bar configured to emit multiple beams. Many of the examples and embodiments used herein describe using a diode bar; however, it is contemplated that any emitter and in particular emitters having optical gain elements and particularly those with broad gain bandwidth may be used.

Additionally, some prior art defines the term “stack or stacking dimension” referred to as two or more arrays stacked together, where the beams' fast dimension is the same as the stacking dimension. These stacks were pre-arranged mechanically or optically. However, for purposes of this application a stack refers to a column of beams or optical gain elements and may or may not be along the fast dimension. Particularly, as discussed above, individual beams or elements may be rotated within a stack or column.

The individual slow or fast dimension of the emitters of the array may also be aligned along the array dimension, but this alignment is not to be assumed. This is important because some embodiments described herein individually rotate the slow dimension of each beam aligned along an array or row. Additionally, the slow axis of a beam may refer to the wider dimension of the beam exiting the optical gain medium and is typically also the slowest diverging dimension, while the fast axis usually refers to the narrower dimension of the beam and is typically the fastest diverging dimension. The slow axis may also refer to single mode beams

In some embodiments it is useful to note that the array dimension and the slow dimension of each emitted beam are initially oriented across the same axis; however, those dimensions, as described in this application, may become oriented at an offset angle with respect to each other. In other embodiments, the array dimension and only a portion of the emitters arranged along the array dimension are perfectly aligned. For example, the array dimension of a diode bar may have emitters arranged along the array dimension, but because of smile (often a deformation or bowing of the bar) individual emitters' slow emitting dimension is slightly skewed or offset from the array dimension.

Aspects and embodiments herein relate to high-power and/or high-brightness multi-wavelength stabilized systems that generate a combined or coaxial beam from very low output power to hundreds and even to megawatts of output power. The combined beam may have a varying beam product parameters as a result of intentional placement of collecting optics and dispersive elements used in the WBC systems described herein.

Wavelength beam combining methods have been developed to combine asymmetrical beam elements across their respective slow or fast axis dimension. One advantage this invention seeks to provide is the ability to selectively-reconfigure input beams either spatially or by orientation to be used in slow and fast axis WBC methods, as well as a hybrid of the two. Another advantage is to selectively-reconfigure input beams when there is a fixed-position relationship to other input beams.

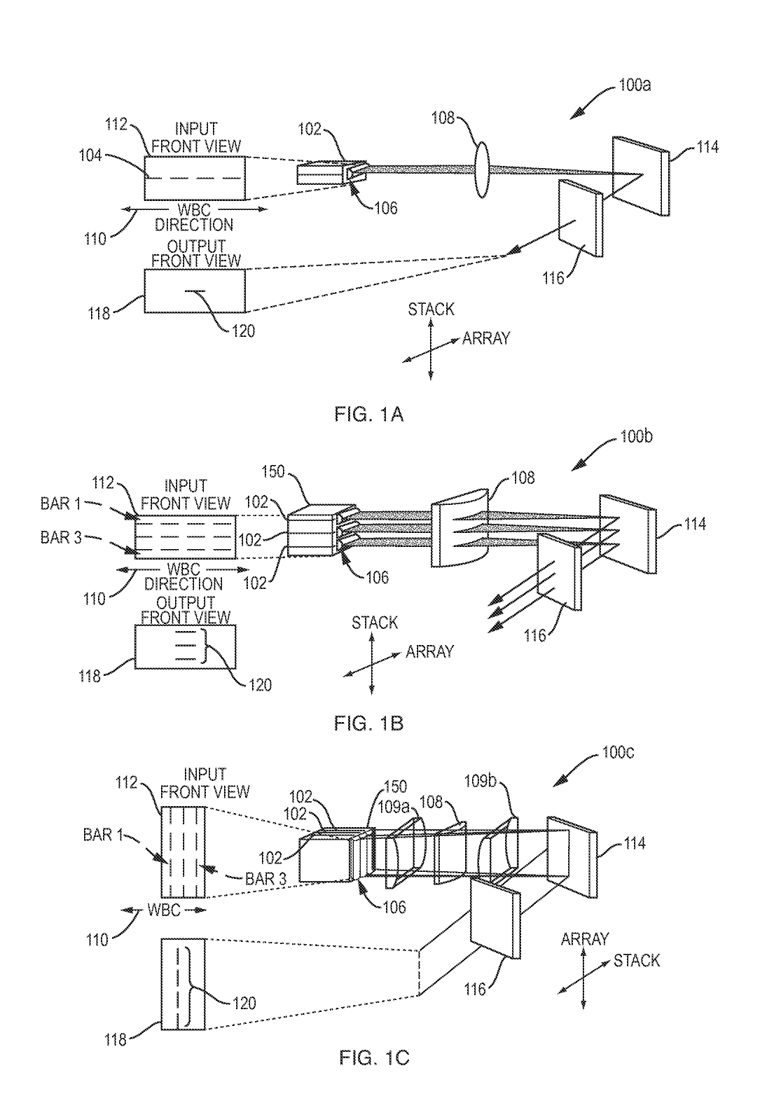

FIG. 1A illustrates a basic WBC architecture. In this particular illustration, WBC is performed along the array dimension or slow dimension for broad-area emitters. Individual beams 104 are illustrated in the figures by a dash or single line, where the length or longer dimension of the beam (dash) represents the array dimension or slow diverging dimension for broad-area emitters and the height or shorter dimension represents the fast diverging dimension. The emitters of diode bar 102 are aligned in a manner such that the slow dimension ends of each emitted beam 104 are aligned to one another side by side along a single row—sometimes referred to as an array. In some configurations a collimation lens 106 is used to collimate each beam along the fast diverging dimension. The collimation optics may be composed of separate fast axis collimation lenses and slow axis collimation lenses.

An optical element 108 is used to combine each beam along the WBC dimension 110 as shown by the input front view 112. Optical element 108 may be a cylindrical or spherical lens or mirror. The optical element 108 then overlaps the combined beam onto a dispersive element 114 (here shown as a reflecting diffraction grating). The first-order diffracted beams are incident onto a partially reflecting mirror. A resonator is formed between the back facet of the optical gain elements and the partially reflecting mirror. As such, the combined beam is then transmitted as a single output profile onto an output coupler 116. This output coupler then transmits the combined beams 120, as shown by the output front view 118. The output coupler 116 may be a partially reflective mirror or surface or optical coating and act as a common front facet providing wavelength stabilized feedback for all the optical gain elements in diode array 102. The feedback is directed toward dispersive element 114, which filters it into unique wavelengths where it is redirected back into each emitter.

Similarly, FIG. 1B illustrates a stack of laser diode bars each having four emitters where those bars are stacked three high. Like FIG. 1A, the input front view 112 of FIG. 1B, which in this embodiment is a two-dimensional array of beams, is combined to produce the output front view 118 or a single column of beams 120. The emitted beams in WBC system 100b were combined along the array dimension. Here optical element 108 is a cylindrical lens used to combine the beams along the array. However, a combination of optical elements or optical system can be used as such that the optical elements arrange for all the beams to overlap onto the dispersive element and make sure all the beams along the non-beam-combining dimension are propagating normal to the output coupler. A simple example of such an optical system would be a single cylindrical lens with the appropriate focal length along the beam-combining dimension and two cylindrical lenses that form an afocal telescope along the non beam-combining dimension wherein the optical system projects images onto the partially reflecting mirrors. Many variations of this optical system can be designed to accomplish the same functions.

The array dimension of FIG. 1B is also the same axis as the slow dimension of each emitted beam in the case of multimode diode laser emitters. Thus, this WBC system may also be called slow axis combining, where the combining dimension is the same dimension of the beams.

By contrast, FIG. 1C illustrates a stack 150 of laser diode arrays 102 forming a two-dimensional array of beams, as shown by 120, where instead of combining along the array dimension as in FIGS. 1A-B, the WBC dimension now follows along the stack dimension of the emitters. Here, the stacking dimension is also aligned with the fast axis dimension of each of the emitted beams. The input front view 112 is now combined to produce the output front view 118 wherein a single column 120 of beams is shown.

There are various drawbacks to all three configurations. One of the main drawbacks of configuration shown in FIGS. 1A and 1B is that beam combining is performed along the array dimension. As such wavelength stabilizing operation is highly dependent on imperfections of the diode array. A disadvantage of configuration 1C is that the output beam quality is limited to that of a single laser bar and external beam shaping for beam symmetrization may be required for efficient coupling into a fiber.

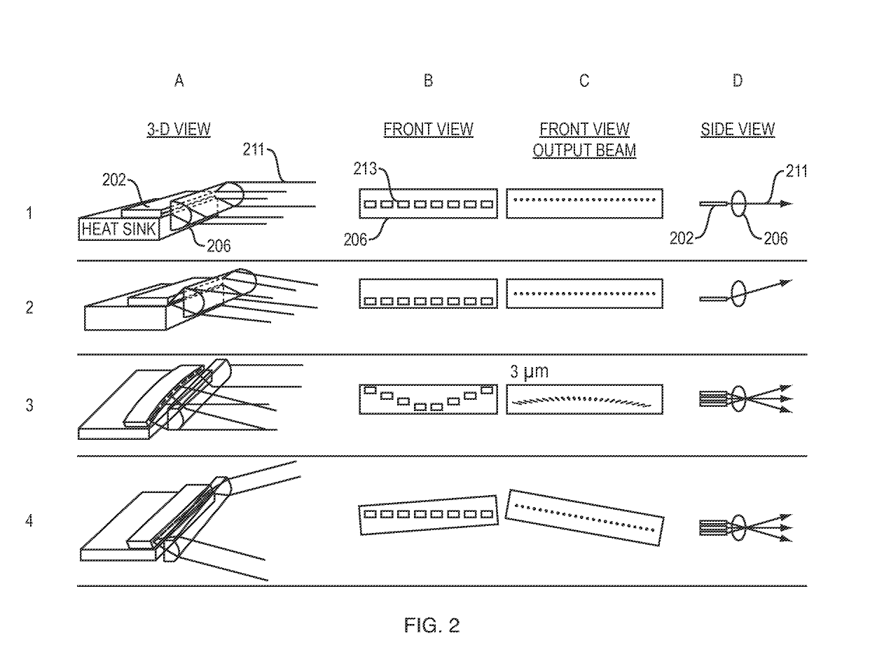

As illustrated in FIG. 2, a diode array with smile or pointing errors, may prevent feedback from the WBC system's optical elements, which consist of the collecting lens, grating, and output coupler, to couple back to the diode optical gain elements. Some negative effects of this mis-coupling are that the WBC laser breaks wavelength lock and the diode laser or related packaging may be damaged from mis-coupled or misaligned feedback not re-entering the optical gain medium. For instance the feedback may hit some epoxy or solder in contact or in close proximity to a diode bar and cause the diode bar to fail catastrophically.

Row 1 of FIG. 2 shows a single laser diode bar 202 without any errors. The embodiments illustrated are exemplary of a diode bar mounted on a heat sink and collimated by a fast-axis collimation optic 206. Column A shows a perspective or 3-D view of the trajectory of the output beams 211 going through the collimation optic 206. Column D shows a side view of the trajectory of the emitted beams 211 passing through the collimation optic 206. Column B shows the front view of the laser facet with each individual optical gain element 213 with respect to the collimation optic 206. As illustrated in row 1, the optical gain elements 213 are perfectly straight. Additionally, the collimation optic 206 is centered with respect to all the optical gain elements 213. Column C shows the expected output beam from a system with this kind of input. Row 2 illustrates a diode laser array with pointing error. Shown by column B of row 2 the optical gain elements and collimation optic are slightly offset from each other. The result, as illustrated, is the emitted beams having an undesired trajectory that may result in reduced lasing efficiency for a multi-wavelength stabilizing system. Additionally, the output profile may be offset to render the system ineffective or cause additional modifications. Row 3 shows an array with packaging error. The optical gain elements no longer sit on a straight line, and there is curvature of the bar. This is sometimes referred to as ‘smile.’ As shown on row 3, smile can introduce even more trajectory problems as there is no uniform path or direction common to the system. Column D of row 3 further illustrates beams 211 exiting at various angles. Row 4 illustrates a collimation lens unaligned with the optical gain elements in a twisted or angled manner. The result is probably the worst of all as the output beams generally have the most collimation or twisting errors. In most systems, the actual error in diode arrays and stacks is a combination of the errors in rows 2, 3, and 4. In both rows 2 and 3, using VBG's and diffraction gratings, optical gain elements with imperfections results in output beams no longer pointing parallel to the optical axis. These off optical axis beams result in each of the optical gain elements lasing at different wavelengths. The plurality of different wavelengths increases the output spectrum of the system to become broad as mentioned above.

One of the advantages of performing WBC along the stacking dimension (here also primarily the fast dimension) of a stack of diode laser bars is that it compensates for smile as shown in FIG. 2. Pointing and other alignment errors are not compensated by performing WBC along the array dimension (also primarily slow dimension). A diode bar array may have a range of emitters typically from 19 to 49 or more. As noted, diode bar arrays are typically formed such that the array dimension is where each emitter's slow dimension is aligned side by side with the other emitters. As a result, when using WBC along the array dimension, whether a diode bar array has 19 or 49 emitters (or any other number of emitters), the result is that of a single emitter. By contrast, when performing WBC along the orthogonal or fast dimension of the same single diode bar array, the result is each emitted beam increases in spectral brightness, or narrowed spectral bandwidth, but there is not a reduction in the number of beams (equivalently, there is not an increase in spatial brightness).

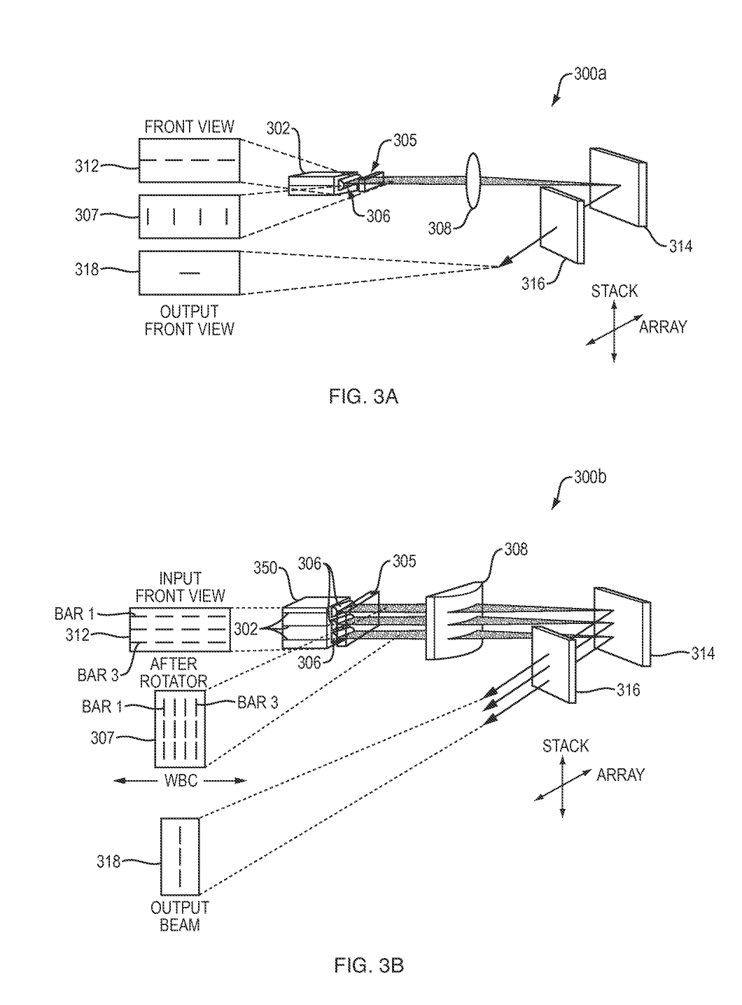

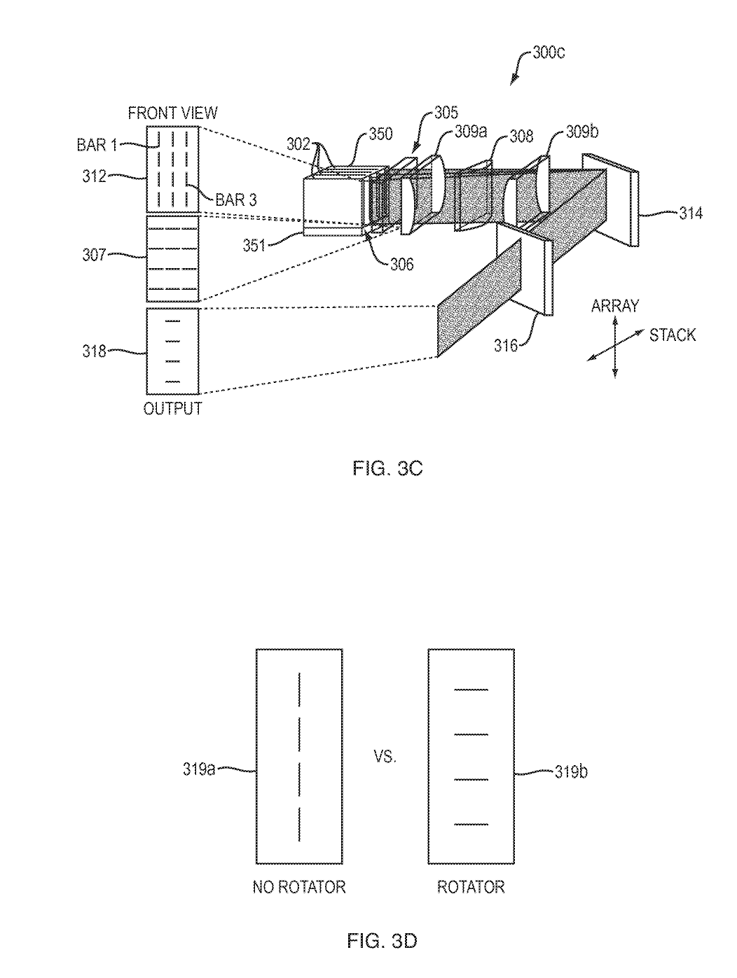

One embodiment that addresses this issue is illustrated in FIG. 3A, which shows a schematic of WBC system 300a with an optical rotator 305 placed after collimation lenses 306 and before the optical element 308. It should be noted the optical element 308 may be comprised of a number of lenses or mirrors or other optical components. The optical rotator 305 individually rotates the fast and slow dimension of each emitted beam shown in the input front view 312 to produce the re-oriented front view 307. It should be noted that the optical rotators can selectively rotate each beam individually irrespective of the other beams or in some instances it is possible to rotate all the beams through the same angle simultaneously. It should also be noted that a cluster of two or more beams can be rotated simultaneously. The resulting output, after WBC is performed along the array dimension, is shown in output front view 318 as a single emitter. Dispersive element 314 is shown as a reflection diffraction grating, but may also be a dispersive prism, a grism (prism+grating), transmission grating, or Echelle grating.

This particular embodiment illustrated in FIG. 3A shows only four laser emitters; however, as discussed above this system could take advantage of a laser diode array that included many more elements, e.g., 49. Additionally, this embodiment shows a single bar having a particular wavelength band (example at 976 nm) but in actual practice it can be composed of multiple bars, all at the same particular wavelength band, arranged side-by-side. Furthermore, multiple wavelength bands (example 976 nm, 915 nm, and 808 nm), with each band composing of multiple bars, can we combined in a single cavity. Because WBC was performed across the fast dimension of each beam it easier to design a system with a higher brightness (higher efficiency due to insensitivity due to bar imperfections); additionally, narrower bandwidth and higher power output are all achieved.

FIG. 3B shows an implementation similar to FIG. 3A except that stack 350 of laser arrays 302 forms a 2-D input profile 312. WBC system 300b is comprised of collimation lens(es) 306, optical rotator 305, optical element 308, dispersive element 308 (here a diffraction grating), and an output coupler 316 with a partially reflecting surface. Each of the beams is individually rotated by optical rotator 305 to form an after rotator profile 307. The WBC dimension is along the array dimension, but with the rotation each of the beams will be combined across their fast axis. Fast axis WBC produces outputs with very narrow line widths and high spectral brightness. These are usually ideal for industrial applications such as welding. After optical element 308 overlaps the rotated beams onto dispersive element 314 a single output profile is produced and partially reflected back through the cavity into the optical gain elements. The output profile 318 is now comprised of a line of three (3) beams that is quite asymmetric.

FIG. 3C shows the same implementation when applied to 2-D optical gain elements. The system consists of 2-D optical gain elements 302, optical rotator 305, optical system (308 and 309a-b) a dispersive element 314, and a partially reflecting mirror 316. FIG. 3C illustrates a stack 350 of laser diode bars 302 with each bar having an optical rotator 305. Each of the diode bars 302 (three total) as shown in WBC system 300c includes four emitters. After input front view 312 is reoriented by optical rotator 305, reoriented front view 307 now the slow dimension of each beam aligned along the stack dimension. WBC is performed along the dimension, which is now the slow axis of each beam and the output front view 318 now comprises single column of beams with each beam's slow dimension oriented along the stack dimension.

Optics 309a and 309b provide a cylindrical telescope to image along the array dimension. The function of the three cylindrical lenses is to provide two main functions. The middle cylindrical lens 308 is the collecting lens and its main function is to collect all the beams and direct them onto the dispersive element. The two other cylindrical lenses 309a and 309b form an afocal cylindrical telescope along the non-beam combining dimension. Its main function is to make sure all optical gain elements along the non-beam combining are propagation normal to the partially reflecting mirror. As such the implementation as shown in FIG. 3C has the same advantages as the one shown in FIG. 1C.

However, unlike the implementation as shown in FIG. 1C the output beam is not the same as the input beam. The number of emitters in the output beam 318 in FIG. 3C is the same as the number of bars in the stack. For example, if the 2-D laser source consists of a 3-bar stack with each bar composed of 49 emitters, then the output beam in FIG. 1C is a single bar with 49 emitters. However, in FIG. 3C the output beam is a single bar with only 3 emitters. Thus, the output beam quality or brightness is more than one order of magnitude higher. This brightness improvement is very significant for fiber-coupling. For higher power and brightness scaling multiple stacks can be arranged side-by-side.

To illustrate this configuration further, for example, assume WBC is to be performed of a 3-bar stack, with each bar comprising of 19 emitters. So far, there are three options. First, wavelength beam combining can be performed along the array dimension to generate 3 beams as shown in FIG. 1B. Second, wavelength beam combining can be performed along the stack dimension to generate 19 beams a shown FIG. 1C. Third, wavelength beam combining can be performed along the array dimension using beam rotator to generate 19 beams as shown FIG. 3C. There are various trade-offs for all three configuration. The first case gives the highest spatial brightness but the lowest spectral brightness. The second case gives the lowest spatial brightness with moderate spectral brightness and beam symetrization is not required to couple into a fiber. The third case gives the lowest spatial brightness but the highest spectral brightness and beam symmetrization is required to couple into an optical fiber. In some applications this more desirable.

To illustrate the reduction in asymmetry FIG. 3D has been drawn showing the final output profile 319a where the system of 300b did not have an optical rotator and output profile 319b where the system includes an optical rotator. Though these figures are not drawn to scale, they illustrate an advantage achieved by utilizing an optical rotator, in a system with this configuration where WBC is performed across the slow dimension of each beam. The shorter and wider 319b is more suitable for fiber coupling than the taller and slimmer 319a.

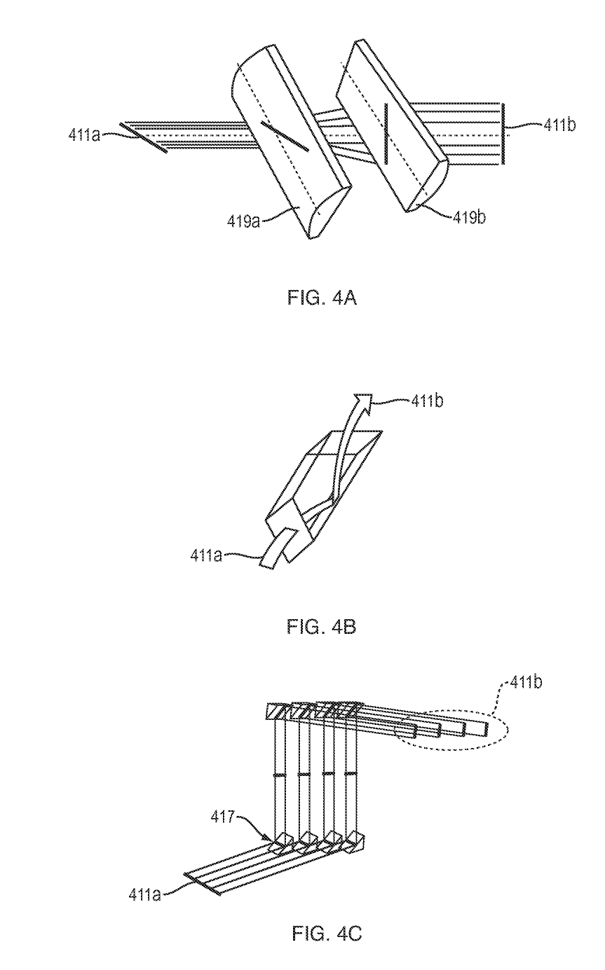

Examples of various optical rotators are shown in FIG. 4A-C. FIG. 4A illustrates an array of cylindrical lenses (419a and 419b) that cause input beam 411a to be rotated to a new orientation at 411b. FIG. 4B similarly shows input 411a coming into the prism at an angle, which results in a new orientation or rotation beam 411b. FIG. 4C illustrates an embodiment using a set of step mirrors 417 to cause input 411a to rotate at an 80-90 degree angle with the other input beams resulting in a new alignment of the beams 411b where they are side by side along their respective fast axis. These devices and others may cause rotation through both non-polarization sensitive as well as polarization sensitive means. Many of these devices become more effective if the incoming beams are collimated in at least the fast dimension. It is also understand that the optical rotators can selectively rotate the beams at various including less than 90 degrees, 90 degrees and greater than 90 degrees.

The optical rotators in the previous embodiments may selectively rotate individual, rows or columns, and groups of beams. In some embodiments a set angle of rotation, such as a range of 80-90 degrees is applied to the entire profile or subset of the profile. In other instances, varying angles of rotation are applied uniquely to each beam, row, column or subset of the profile. For instance, one beam may be rotated by 45 degrees in a clockwise direction while an adjacent beam is rotated 45 degrees in a counterclockwise direction. It is also contemplated one beam is rotated 10 degrees and another is rotated 70 degrees. The flexibility the system provides can be applied to a variety of input profiles, which in turn helps determine how the output profile is to be formed. For instance, performing WBC along an intermediate angle between the slow and fast dimension of the emitted beams is also well within the scope of the application.

In the above WBC embodiments folding mirrors or optics are not shown. However, in many practical applications, folding mirrors are used to confine the beam path to a single box that is more portable or confined for use in various applications. For example, in some embodiments described above, a directing a cylindrical lens 108 is placed between the emitters and the dispersive element to focus or cause the plurality of beams along a beam combining dimension to converge on or near the dispersive element. If this lens 108 is placed a focal length on each side away from the emitter and the dispersive element that means the minimum path length between the emitters and the dispersive element is at least two times the focal length of 108. This may be up to a meter in length. Thus, to decrease the overall footprint of the WBC system folding mirrors are inserted between these optical elements to decrease a meter in length to ⅓ of a meter, which allows the WBC system to be placed in a more compact housing. Additional folding mirrors placed after the dispersive element may also be used in conjunction with other optical elements for various other purposes.

### Retro Reflectors for Increase Stability

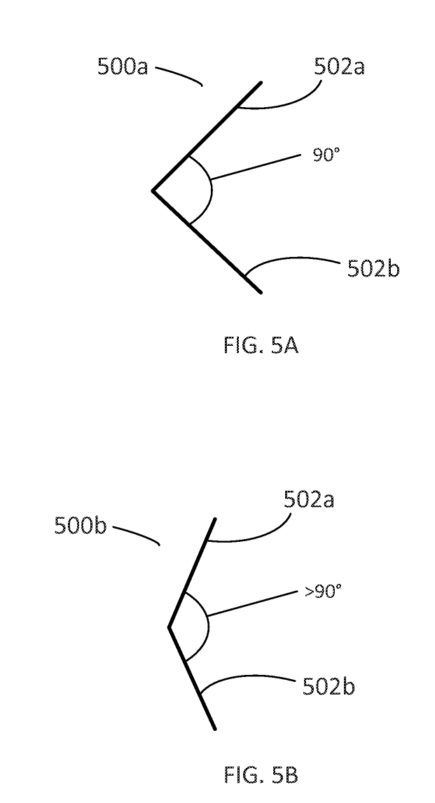

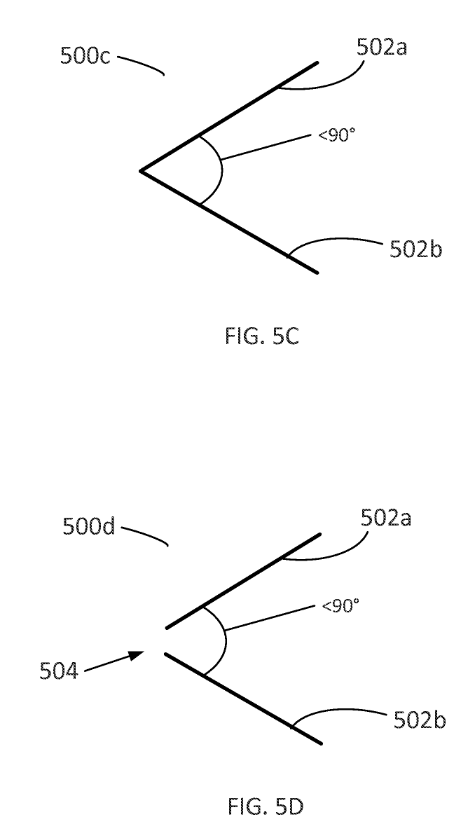

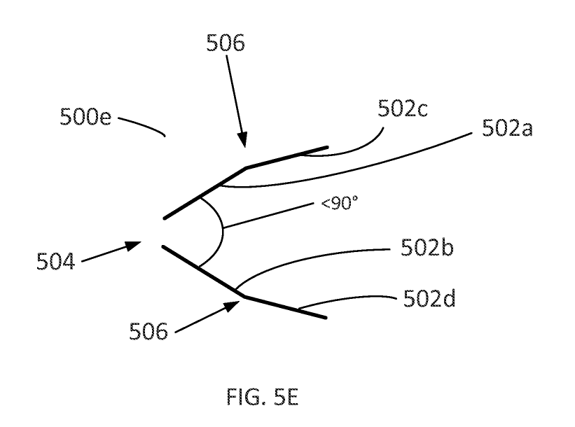

FIGS. 5A-E illustrate various retro reflectors that may be used in a WBC system to increase stability. FIG. 5A illustrates retro reflector 500a where the angle between two reflective surfaces 502a-b is 90°. These kind of retro reflectors are often called porro prisms; however, for purposes of this application at least two reflective surfaces having an angle of less than (FIG. 5C) or greater than 90° (FIG. 5B) may be used to help stabilize WBC systems. In addition, some retro reflectors have two reflective surfaces that are mounted in a fixed position relative to each other, but have an opening 504 instead of vertex where other reflective surfaces meet such as in FIGS. 5A-C. Other retro reflectors include multi-angle surfaces or multiple reflective surfaces that have a fixed position about each other, such as retro reflector 500e shown in FIG. 5E. Here 500e has four reflective surfaces 502a-d, an opening 504 instead of vertex about which the reflective surfaces are positioned and vertexes 506 where the reflective surfaces meet and form an angle. Some retro reflectors not shown include those having curved surfaces including some where the curvature varies across the surface. Both 2-D and 3-D retro reflectors are contemplated.

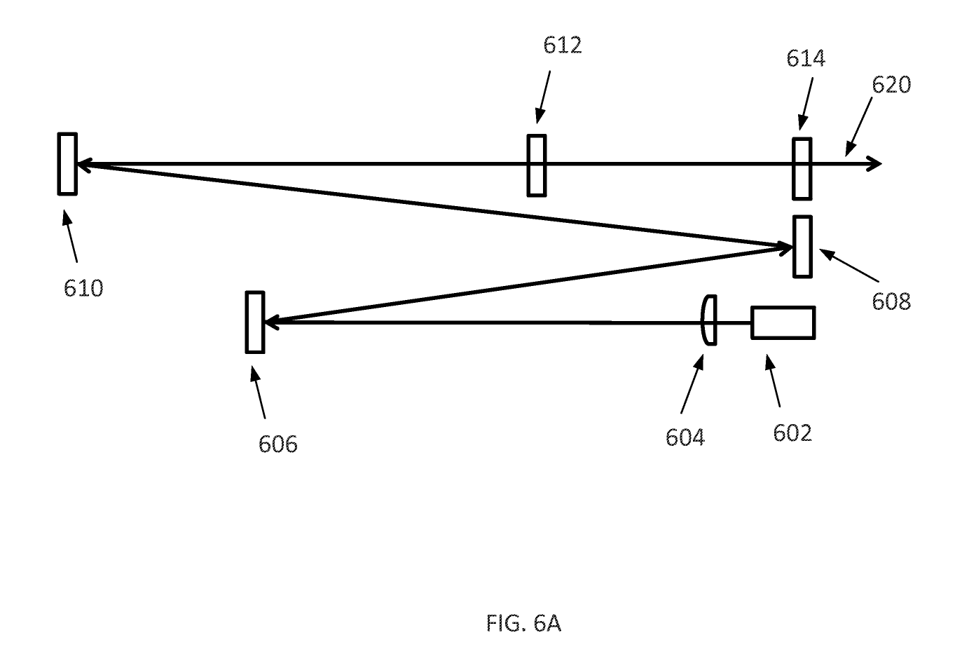

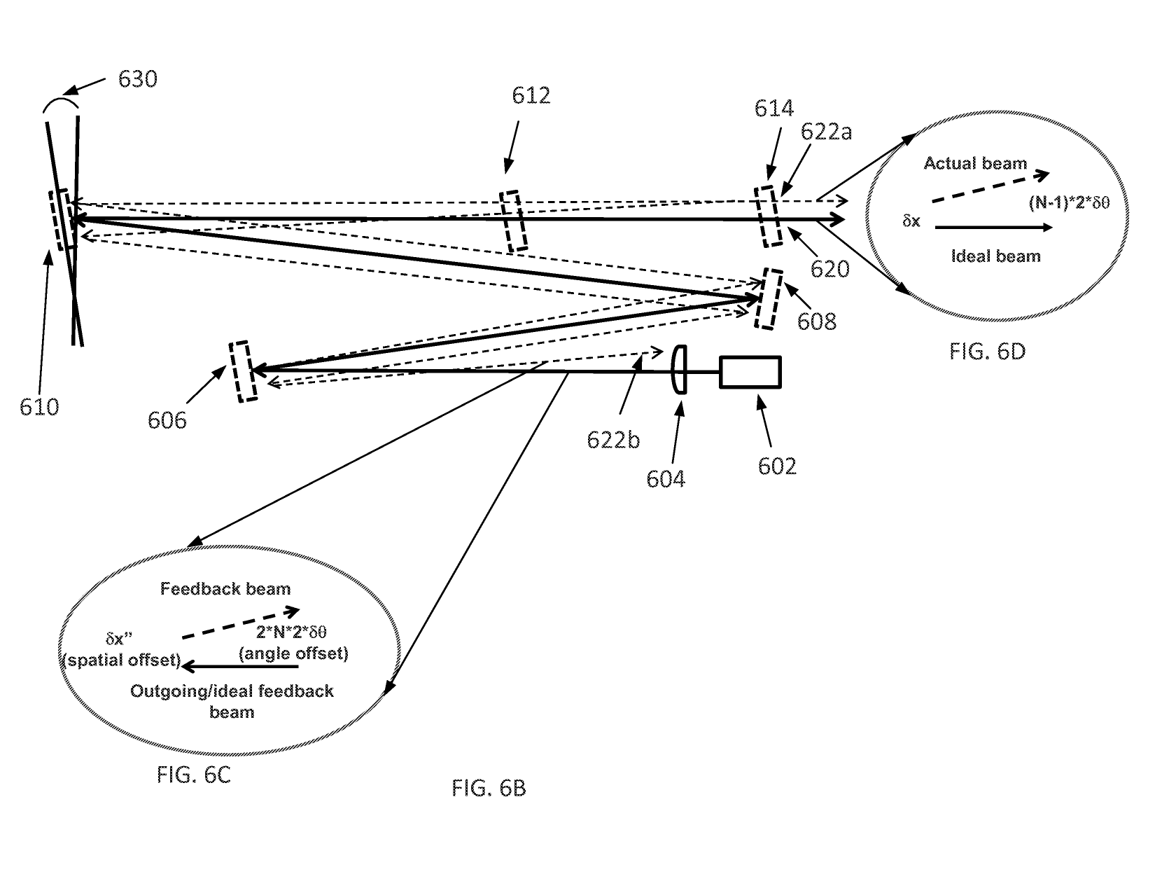

FIGS. 6A-B illustrate a basic schematic of a WBC system incorporating a plurality of mirrors and the angular and spatial feedback of an actual beam versus ideal beam. A diode bar 602 emits a plurality of beams that pass through a SAC lens 604 and encounter a first mirror 606, which is an interleaver mirror used to interleave emitted beams from multiple diode bars in order to decrease the spatial distance between emitters in the system. From mirror 606 the beams encounter another mirror 608, which redirects the beams onto mirror 610 and then onto mirror 612, which is drawn as a pass through mirror, but in some embodiments this mirror is used to redirect the beams out of plane and then onto partially reflective output couple 614, which transmits output beam 620 and reflects a portion back towards the original emitters 602. Correct feedback, in WBC systems, allows each individual emitter to properly lase about a unique wavelength, which in turn helps create a high-power multi-wavelength output beam profile that in some cases may have the beam quality of a single emitter.

However, as mentioned above, multiple reflective surfaces, though decreasing the footprint of a WBC system, in turn increases the need for maintaining accurate optical positions across multiple optical elements. In a blade or other housing system where each of the optical elements are mounted, heating, cooling, vibration and other stress may cause the mounts to shift, thus altering the ideal beam path 620 to an actual beam path 622 as shown in FIG. 6B. Here 630 illustrates the pitch, δθ or position-from-normal for mirror 610, which for purposes of this example may be assumed to be the same for each of the mirrors shown. For the formulas shown in FIGS. 6C-D, N is equal to the number of mirrors, which is used to determine the spatial shift δx for the output and the feedback beams.

If in one scenario the following parameters are used:
1) Beam divergence is about 2.8 mrad so 2*N*2*δθ<=0.28 mrad or δθ<=0.014 mrad
2) N=5 total number of mirrors
3) 2 factorial due to mirror (δθ pitch turns into 2*δθ), because of the double pass path
4) Spacing between mirrors is:
   a. 606-614˜1200 mm is distance from inter-leaver to coupler
   b. 608-614˜1000 mm distance M1 to coupler
   c. 610-614˜700 mm distance from M2 to coupler
   d. 612-614˜400 mm distance from M3 to coupler
   e. 604-614˜1500 mm distance from coupler to SAC
5) Beam size at the output coupler is ˜3.5 mm so δx″<=0.35 mm
6) δx″=2*δθ*(a+b+c+d+e)<=0.35 mm
7) δx″=2*0.014 mrad*4800 mm=0.13 mm<=0.35 mm
8) If δθ˜0.2 mrad at worst
9) then the feedback angle offset˜4 mrad, and
10) the feedback spatial overlap offset˜1.9 mm, which would result in zero feedback to each of the emitters.

Thus, the above example helps illustrate the need for a solution to help maintain stabilization in a WBC system having a plurality of mirrors.

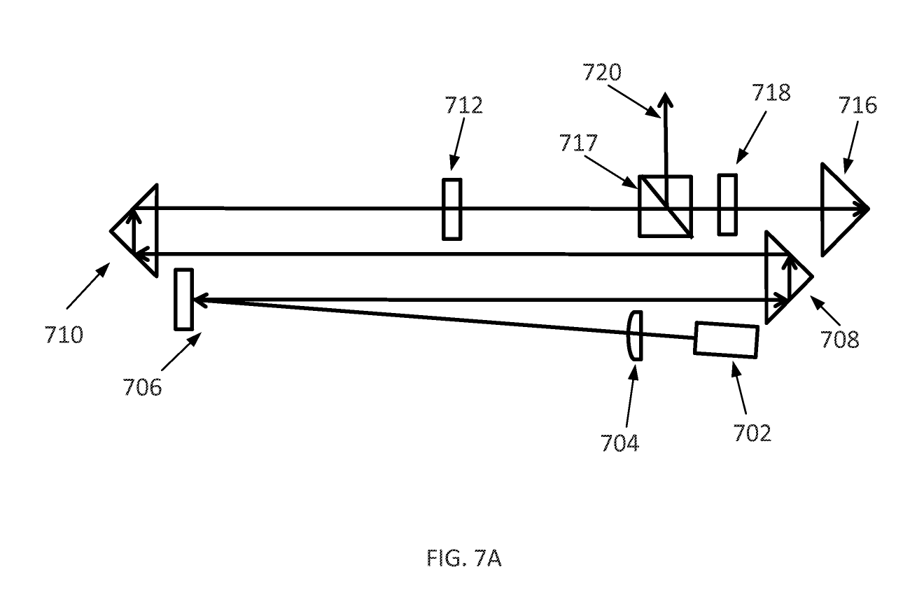

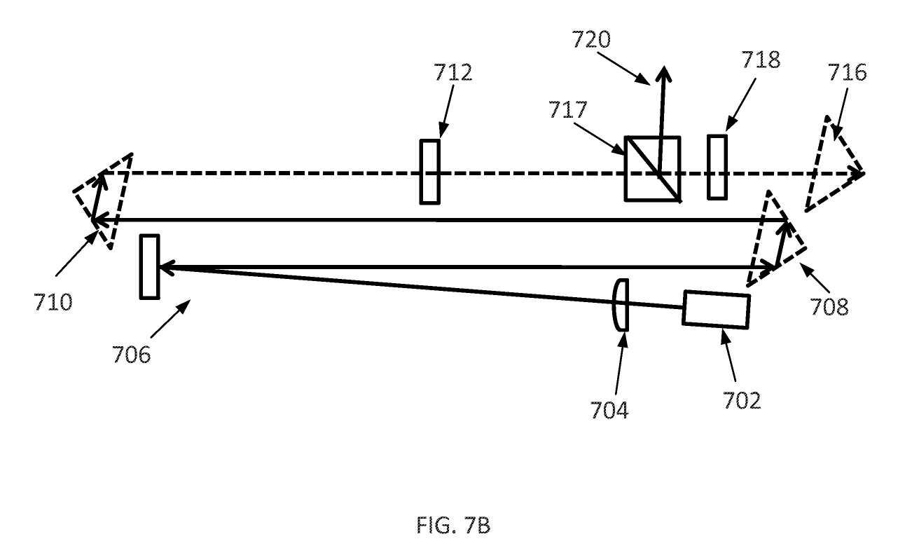

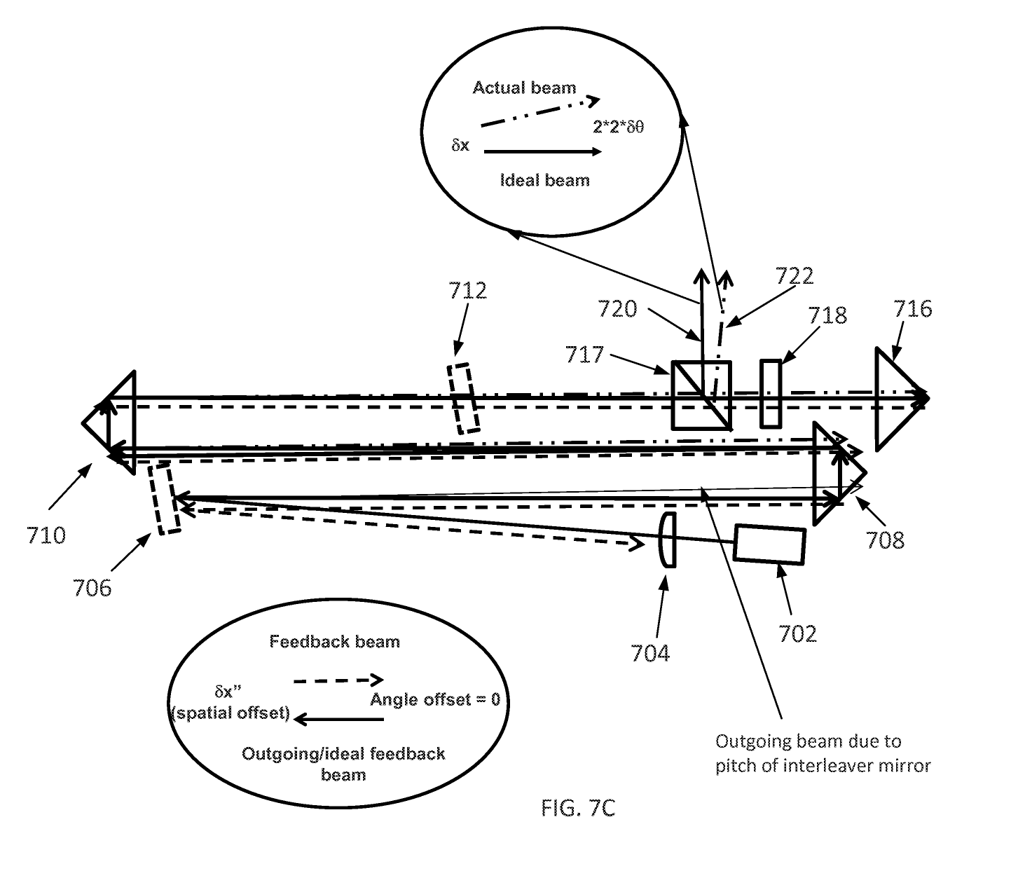

One solution for the setup shown in FIGS. 6A-D is illustrated in FIG. 7A where 3 of the 5 mirrors are replaced with retro reflectors. The output coupler 614 is replaced by a quarter wave plate 718, a retro reflector 716, and a polarizing beam splitter cube 717. This helps to increase the stabilization of the system by making mirrors 798, 710, and 716 less susceptible to spatial or angular shifting as illustrated in FIG. 7B where each has been rotated, but the beam path still runs parallel to maintain and not perpetuate angular or spatial shifting.

FIG. 7C further illustrates the amount of shifting the actual beam output and feedback paths may incur compared to an ideal beam based on the replacing of the retro reflectors for some of the mirrors. For example the number of mirrors or N that contribute to spatial shifting (δx) is reduced from 5 to 2, which reduces the spatial shifting by 60%, if we assume pitch (δθ) is the same for both mirrors. Furthermore, the feedback angle offset is now reduced to zero because of the parallel paths created by the retro reflectors.

The optical schematic shown in FIG. 9 illustrating a WBC kilowatt laser system 1100 configured to couple up to a kilowatt of power or more into a single optical fiber benefits from incorporating retro reflectors for 1116, 1128 and 1130, which would otherwise be mirrors to keep the system compact. The source lasers 1102 are mechanical stacks of diode laser bars. The source diode lasers may provide greater than 1 kW per stack of which there are two mechanical stacks 1102 installed in the schematic drawn. The mechanical stacks of diode lasers comprise the source emitters 1102 in this laser system 1100. The resonator comprises the external cavity for wavelength beam combination. The post-resonator comprises the beam-shaping optics including a polarization multiplexer 1134 and optical reconfiguration element(s) 1136 that transform the bar-shaped asymmetrical beam profile emerging from the resonator into a more symmetric, square beam profile that is suitable for fiber coupling. The post-resonator also includes anamorphic optics 1138, the fiber optical module (FOM) 1140, which includes in part a focusing element for fiber coupling, and the coupling fiber 1142.

The mechanical diode stacks 1102 employed in 1100 may be commercially available diode laser stacks. For example in one embodiment, two 15-bar stacks are used and each bar in the stack consists of 19 emitters; other types of diode laser bars may also be used, including 49-emitter bars. For the same embodiment, 3.5 mm cavity length bars may be used, but cavity lengths having a range of 1 to 5 mm are workable. Each multi-mode emitter in the bar usually has a stripe width of 100 microns. Each diode laser bar has a fast-axis collimation (FAC) and slow-axis collimation (SAC) lens shown as 1106 after the facet of the emitters.

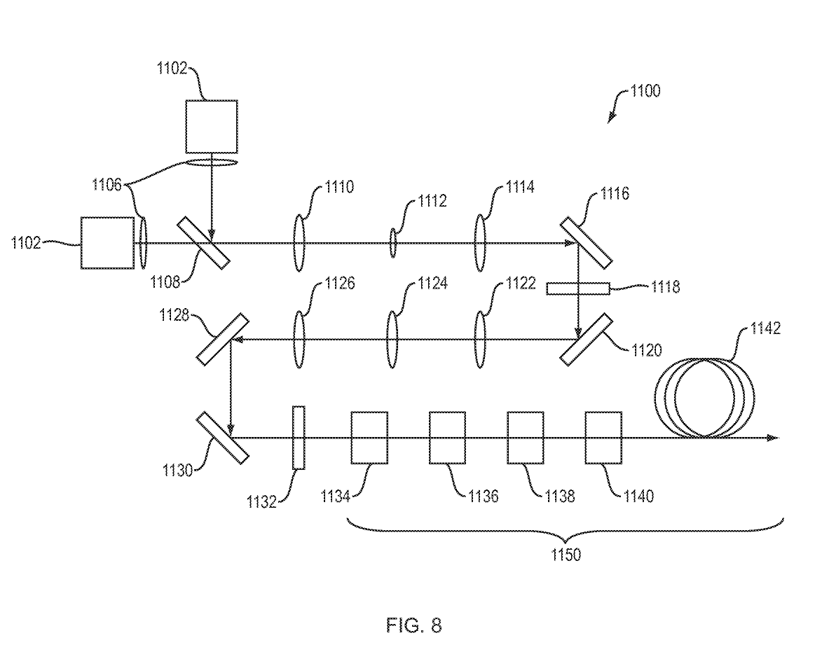

For the implementation shown in FIG. 8, if each bar contributes approximately 80 W of laser power at 976 nm, then for 2×15-bar stacks (30 total bars) the total raw power from the stacks is about 2.4 kW. Though using retro reflectors won't eliminate the need for a heat management system, they do allow the system to be more flexible and focus on other important components, such as the diode bars.

The optical configuration of the WBC resonator includes a spatial interleaver 1108 and the following optics: L1 1110, L2 1112, L3 1114, M4 1116, wave plate 1118, grating 1120, L4 1122, L5y 1124, L5x 1126, M5 1128, M6 1130, and output coupler 1132. The spatial interleaver 1108 serves to spatially interleave the optical output from two mechanical diode laser stacks 1102. Since the thickness of each (implemented) micro channel cooler is approximately 2 mm, each mechanical stack has a bar pitch of 2 mm. The spatial interleaver 1108 may be an optical window having stripes of alternating HR and AR coatings at a pitch of 1 mm (other designs are possible). When placed at a 45 degree angle between the two stacks (the stacks are angled at 90 degrees with respect to each other), the spatial interleaver 1108 allows the output bars to be interleaved spatially, effectively resulting in an optical stack of diode laser bars consisting of 30 bars at 1 mm pitch.

The lenses (L1-L5_{xy}), grating 1120, and mirrors (M4-M6 are replaceable with retro reflectors and even output coupler 1132 may be replaced by that shown in FIGS. 7A-C) of the resonator may be arranged according to the WBC systems described herein.

An advantage of the laser 1100 is that it may deliver high brightness, up to kW-class and above, diode laser output to many applications (including industrial and military applications) in a relatively efficient and compact, fully self-contained and turn-key system. The entire laser system may fit inside of a standard 19-inch rack commonly used for electronics equipment. The power conversion efficiency of the laser system may be in the range of 40% or greater, and such an efficient system dramatically reduces both the power and cooling requirements of the overall laser system.

The post resonator 1150 consists of the polarization multiplexer 1134, the optical reconfiguration element 1136, the anamorphic element 1138, the fiber optical module (FOM) 1140, and the optical fiber 1142. The polarization multiplexer 1134 improves the output beam quality by a factor of two by de-polarizing the laser output and combining the two polarizations spatially. The emitter distribution may be converted from 1×19 to 1×10 after the polarization multiplexer. The optical reconfiguration element 1136, which may consist of a single optical plate with appropriate HR and AR coatings, or other embodiments previously described, redistributes the emitter profile from 1×10 to 5×2. The anamorphic element 1138 may be a series of lenses configured to increase the fill factor of the 5×2 beam distribution and to ensure that the beam is approximately square with a suitable size and numerical aperture at the far field for fiber coupling. Other optical conversion factors for the post-resonator components are also possible.

The fiber-optical module (FOM) 1140 may consist of a lens and translation system used to focus the laser output into the fiber 1142, may be actively cooled so as to handle kW-class operation. The optical fiber 1142 may be compatible with LLK-B optical fiber and have a core diameter of 200 μm and a numerical aperture (NA) up to 0.2. Since the optical fiber 1142 approximately preserves NA, it is possible to obtain laser output with NA less than 0.2 depending on the beam quality of the laser beam input to the FOM 1140. Also, high power fiber of any other type may be used with success, including, but not limited to, QBH and LLK-D fiber.

The above description is merely illustrative. Having thus described several aspects of at least one embodiment of this invention including the preferred embodiments, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A stabilized wavelength beam combiner comprising:
a plurality of emitters each producing a beam;
a collecting optic configured to receive and deliver the beams onto a dispersive element, wherein the dispersive element transmits the beams as a combined beam profile;
a partially-reflecting output coupler arranged to receive the combined beams from the dispersive element, to reflect a portion of the combined beams toward the dispersive element, and to transmit the combined beams as a multi-wavelength beam comprising optical radiation having a plurality of wavelengths; and
at least two retro reflectors disposed along the optical path of the beams between the emitters and the partially reflective output coupler.

2. The stabilized wavelength beam combiner of claim 1, wherein at least two of the beam emitters have a fixed-position relationship.

3. The stabilized wavelength beam combiner of claim 1, wherein the beam emitters include a first reflective surface and an optical gain medium.

4. The stabilized wavelength beam combiner of claim 1, further including a collimation optic configured to receive beams from the beam emitters and collimate one or more beams along a dimension of the beam.

5. The stabilized wavelength beam combiner of claim 1, wherein the emitted beams have an asymmetrical profile.

6. The stabilized wavelength beam combiner of claim 1, wherein the partially reflective output coupler is the only non-retro reflector in the system.

7. The retro reflectors of claim 1, wherein the reflective surface is curved.

8. The retro reflectors of claim 1, wherein the angle between reflective surfaces is less than 90 degrees.

9. The retro reflectors of claim 1, wherein the retro reflector is a prism.

10. A stabilized wavelength beam combiner comprising:
a plurality of emitters each producing a beam;
a collecting optic configured to receive and deliver the beams onto a dispersive element, wherein the dispersive element transmits the beams as a combined beam profile;
a polarized beam splitter configured to receive and transmit the combined beams;
a quarter wave plate positioned to receive the combined beams from the beam splitter;
a retro reflector configured to receive and redirect the combined beams from the quarter wave plate back to the quarter wave plate; and
a partially-reflecting output coupler arranged to receive the combined beams from the dispersive element, to reflect a portion of the combined beams toward the dispersive element, and to transmit the combined beams as a multi-wavelength beam comprising optical radiation having a plurality of wavelengths.

11. The stabilized wavelength beam combiner of claim 10, further including; at least additional two retro reflectors disposed along the optical path of the beams between the emitters and the partially reflective output coupler.

12. A wavelength beam combining method including:
selectively rotating electromagnetic beams emitted by a plurality of beam emitters;
directing the selectively rotated beams onto a dispersive element;
transmitting a combined beam profile from the dispersive element;
redirecting a portion of the combined beams back into the beam emitters;
transmitting the combined beams as a multi-wavelength beam comprising optical radiation having a plurality of wavelengths; and
reducing the spatial and angular offset of the output and feedback beams.

13. The method of claim 12, further including:
individually collimating the emitted beams along a dimension prior to selectively rotating the beams.

14. The method of claim 12, wherein at least two of the beam emitters have a fixed-position relationship.

15. The method of claim 12, wherein a post resonator comprised of
a polarization multiplexer,
optical reconfiguration element,
anamorphic element, and
fiber-optic module receives the multi-wavelength beam comprising optical radiation having a plurality of wavelengths.

16. A stabilized multi-wavelength laser system comprising:
a wavelength beam combining resonator comprised of:
a plurality of emitters each producing a beam,
a collecting optic configured to receive and deliver the beams onto a dispersive element, wherein the dispersive element transmits the beams as a combined beam profile,
a polarized beam splitter configured to receive and transmit the combined beams,
a quarter wave plate positioned to receive the combined beams from the beam splitter,
a retro reflector configured to receive and redirect the combined beams from the quarter wave plate back to the quarter wave plate, and
a partially-reflecting output coupler arranged to receive the combined beams from the dispersive element, to reflect a portion of the combined beams toward the dispersive element, and to transmit the combined beams as a multi-wavelength beam comprising optical radiation having a plurality of wavelengths; and
a post resonator including:
a polarization multiplexer,
optical reconfiguration element,
anamorphic element, and
fiber-optic module.
